(19) United States
(12) Patent Application Publication
(10) Pub. No.: US 2022/0374527 A1
(43) Pub. Date: Nov. 24, 2022

(54) DYNAMIC SECURITY EVENT ANALYSIS AND RESPONSE TESTING

(71) Applicants: Todd Beebe, Katy, TX (US); Laura Reuvers, Katy, TX (US)

(72) Inventors: Todd Beebe, Katy, TX (US); Laura Reuvers, Katy, TX (US)

(21) Appl. No.: 17/751,355

(22) Filed: May 23, 2022

Related U.S. Application Data
(60) Provisional application No. 63/202,012, filed on May 23, 2021.

(51) Int. Cl. G06F 21/57

(52) U.S. Cl. CPC G06F 21/577; G06F 2221/034

(57) ABSTRACT

A system and method including the steps for dynamically or randomly selecting one or more criteria of a campaign assessment, in which said one or more criteria of said campaign assessment comprise tests, sub-techniques, techniques, tools, procedures, commands, behaviors, activities, flags, and/or schedule; randomly launching said campaign assessment; and generating a quiz which an analyst accesses by entering details included in a flag output.

### CROSS-REFERENCE TO RELATED APPLICATIONS

The present Utility patent application claims priority benefit of the [U.S. provisional application for patent Ser. No. 63/202,012 entitled “Dynamic Security Event Analysis and Response Testing”, filed on May 23, 2021, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to cyber security systems and methods. More particularly, certain embodiments of the invention relate to cyber security event analysis and response testing.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that connectivity of devices and networks to the Internet have become a must do activity for most organizations around the world. The Internet connections create many paths that criminals and nation state threat actors may take advantage to compromise the organization. The compromises are typically very costly to the business, its employees and investors which may lead to the complete failure of the business.

To help organizations protect themselves much work has been done to investigate and document the techniques used by threat actors. The MITRE organization is one of leading groups working to document and catalog the techniques. The MITRE Organization then created the MITRE ATT&CK matrix which is publicly available and catalogs some of the known tactics and techniques for the many threat actor groups around the world.

Many security products and controls have been introduced over the years to provide detection and prevention alerts for those attempts to compromise the business. The alerts associated with those security controls require significant expertise and diligence to correctly configure, tune, investigate and respond to. Many successful breaches have occurred where those security controls were correctly deployed and triggered alerts but the security analysts reviewing those alerts did not properly diagnose and escalate the alerts. The failure to properly respond had resulted in recurring breaches at organizations around the world.

There are currently systems that may perform automated testing of the security controls to confirm they trigger alerts within the environment like those commonly referred to as breach and adversary simulation tools. The systems may be inadequate to properly test security analysts because they perform scheduled tests running preselected commands, running on specific systems, all of which a security analyst may easily detect so they may be aware they are being tested.

Presently, there is no system that triggers security control alerts within a customer's own environment on dynamically or randomly named systems, using dynamically or randomly named user accounts, with dynamically or randomly named processes and/or a dynamically or randomly selected set of commands which are generally known as threat actor techniques. The utilization of dynamically or randomly selected testing elements better mimic the activity of a real threat actors' activity and significantly reduce or eliminate the likelihood that the security analysts may be able to determine the campaign assessment is a test campaign. The dynamic and/or randomly determined elements of an adversary simulation assessment may be crucial to accurately measure and uncover critical gaps in the organizations team or managed security providers team analysis conclusions and response activities.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an illustration of an exemplary workflow of a system designed for testing security analysts' ability to properly analyze security events occurring in an environment they are responsible for monitoring which is implemented in accordance with an embodiment of the present invention;

FIG. 1B is an illustration of an exemplary flowchart corresponding to a workflow of a system designed for testing security analysts' ability to properly analyze security events occurring in an environment they are responsible for monitoring which is implemented in accordance with an embodiment of the present invention;

FIG. 1C is an illustration of an exemplary continuation flowchart corresponding to a workflow of a system designed for testing security analysts' ability to properly analyze security events occurring in an environment they are responsible for monitoring which is implemented in accordance with an embodiment of the present invention;

FIG. 2 is a block diagram depicting an exemplary client/server system which may be used by an exemplary web-enabled/networked embodiment of the present invention; and

FIG. 3 illustrates a block diagram depicting a client/server communication system, which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing may mean that such an invention and claims may also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A “computer” may refer to one or more apparatus and/or one or more systems that may be capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks may be performed by local and remote processing devices that may be linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein may be implemented in an operating environment comprising computer-executable instructions (e.g., software) installed on a computer, in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces to a variety of operating systems. Although not limited thereto, computer software program code for carrying out operations for aspects of the present invention may be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network may be a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet may be a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer may read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols, such as Bluetooth, TDMA, CDMA, 3G.

Where databases may be described, it will be understood by one of ordinary skill in the art that (i) alternative database structures to those described may be readily employed, (ii) other memory structures besides databases may be readily employed. Any schematic illustrations and accompanying descriptions of any sample databases presented herein may be exemplary arrangements for stored representations of information. Any number of other arrangements may be employed besides those suggested by the tables shown. Similarly, any illustrated entries of the databases represent exemplary information only; those skilled in the art will understand that the number and content of the entries may be different from those illustrated herein. Further, despite any depiction of the databases as tables, an object-based model could be used to store and manipulate the data types of the present invention and likewise, object methods or behaviors may be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Chrome, Edge, Internet Explorer, Safari, FireFox, or the like), but should be broadly construed to refer to any client-side rendering engine that may access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be understood, however, that all of these and similar terms are to be associated with the appropriate physical quantities and may be merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” may include generic structure (e.g., generic circuitry) that may be manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that may be adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media may be any available media that may be accessed by a general purpose or special purpose computer, including the functional design of any special purpose processor as discussed above. By way of example, and not limitation, such non-transitory computer-readable media may include RAM, ROM, EEPROM, CD-ROM or other optical disk storage, magnetic disk storage or other magnetic storage devices, or any other medium which may be used to carry or store desired program code means in the form of computer-executable instructions, data structures, or processor chip design. When information may be transferred or provided over a network or another communications connection (either hardwired, wireless, or combination thereof) to a computer, the computer properly views the connection as a computer-readable medium. Thus, any such connection may be properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself may be transitory.

In some embodiments of the present invention and variations thereof, relate to systems, methods and applications that dynamically and/or randomly tests, assesses or validates the security event analysis, response, escalation, containment and eradication activities of an organization, entity or managed service providers security analysts involving events or alerts triggered by the systems, methods and applications tests targeting the organizations or entities devices, applications, networks, environments, systems, software, hardware, and accounts and leverages threat actor tools, tactics, techniques, and commands it utilizes to attack, target, breach, gain unauthorized access, or compromise an organization, entity, or individuals devices, applications, networks, environments, systems, software, hardware, or accounts by creating similar security events and triggering similar cyber alerts that may be associated with a real threat actor and providing a timeline of those dynamic or randomly performed activities which allow the organization to assess and validate the security event analysis, response, escalation, containment and eradication activities.

In one embodiment, the system creating a new campaign assessment will be able to enable a feature for the system to define one or more technique and/or sub-technique artifacts or ‘flags’. The flag or flags will be created on one or more test systems during the execution of technique and sub-technique test commands and include information that will associate the test command activity with a specific campaign. The flags may also be associated with one or more quizzes based upon the activity from the campaign.

In one embodiment, the system will track the dwell time of the campaign. Specifically, the dwell time will be calculated for the amount of time between a campaign's initial technique and/or sub-technique test command execution time and date and the time and date when the analyst correctly documents the details of a flag and/or a test command associated with that same campaign assessment in the system

In one embodiment, a user of the system may create a new campaign assessment and enable a feature to send an email to one or more individuals who will be tested or quizzed on that specific campaign. The email notification will be sent once the campaign assessment has concluded. The email notification shall include a hint comprised of one or more details of one of the technique or sub-techniques in the campaign.

In one embodiment, the system may perform an analysis of the existing environment to determine what is common or normal in the environment, including detecting the naming convention of attached systems and user accounts, system usage time frames, common process names, including the parent process name and child process names, directory names, registry key names and values and other process, system and user account related information. Prior to executing a new test or assessment, the system may generate a random collection of process, system, and user account names which it may utilize for its current test. The test may query the environment to determine recently used, but currently not active system and/or user account information and rename the system the current assessment was going to be executed on. The test may create a local account that is named identical to the dormant, but legitimate account, and then begin to launch its dynamically generated list of system processes for the assessment using the dynamically generated local account name.

In one embodiment of the present invention, a system and method are provided for creating a new test campaign assessment and enables a feature to query the environment to determine the existing naming convention of systems in the environment. The system may dynamically and/or randomly generate one or more system names that closely matches the naming convention that is currently not in use. The system may create one or more new system instances or virtual systems and assigns the newly installed or created system instances the newly created system name or names prior to beginning the new campaign assessment.

In one embodiment, a user of the system creating a new campaign assessment and inputs the name or names of one or more existing systems which exist in the environment and are available for use by the system to install or deploy its processes. The system then dynamically or randomly selects one or more of the systems names in the list prior to beginning the new campaign assessment.

In one embodiment, a user of the system creating a new campaign assessment and enables a feature to query the environment to determine the existing naming convention of the user accounts in the environment. The system then dynamically or randomly generates one or more local user account name that closely matches that naming convention that is currently not in use, create a new local account using the new name prior to beginning the new campaign assessment.

In one embodiment, a user of the system creating a new campaign assessment and inputs the name or names of one or more existing user accounts which exist in the environment and are available for use by the system to execute or install its processes. The system then dynamically or randomly selects one or more of the user accounts in the list prior to beginning the new campaign assessment.

In one embodiment, a user of the system creating a new campaign assessment and inputs a list of non-existent user account names determined by the user of the system. The system then dynamically or randomly selects a subset of the user accounts in the user provided list prior to beginning the new campaign assessment.

In one embodiment, a user of the system creating a new campaign assessment enables a feature to query the environment to determine commonly used process names in the environment, the system then generates a process name that closely matches that naming convention that is currently not in use, rename the assessment process name to that new name prior to beginning the new campaign assessment.

In one embodiment, a user of the system creating a new campaign assessment enables a feature to query the environment to determine commonly used process paths in the environment, the system then dynamically or randomly generates a process path that closely matches that process path or paths that are currently not in use, rename the assessment process path to that new name prior to beginning the new campaign assessment.

In one embodiment, a user of the system creating a new campaign assessment enables a feature for the system to select a random set of threat actor technique and/or sub-technique tests, enable those technique and/or sub-technique tests and verify all needed information for those tests are correctly configured prior to beginning the new campaign assessment.

In one embodiment, a user of the system creating a new campaign assessment enables a feature to query the environment to determine the typical working hours in the environment and dynamically set the scheduled working hours for the new campaign assessment prior to beginning the new campaign assessment.

In one embodiment, a user of the system creating a new campaign assessment enables a feature to manually set the scheduled working hours for the new campaign assessment to match the working hours of the time zone associated with the systems being tested prior to beginning the new campaign assessment.

In one embodiment, a user of the system creating a new campaign assessment enables a feature to dynamically or randomly select all criteria of the new campaign assessment including the tests, sub-techniques, techniques, tools, procedures, commands, behaviors, activities and flags and/or schedule and then randomly launches the campaign.

In one embodiment, a user of the system received a report after the conclusion of the assessment which documents a timeline of the activity associated with the assessment. The user of the system may then schedule a team review of the activity involved with the assessment and compare it to the actual behaviors, response, escalation, containment, and eradication activities of the team.

In one embodiment, a user of the system may enable a feature to integrate the system with the user's security ticket management system. This integration will allow the system to dynamically query the ticket management system and associate the systems activities and the tickets within the security ticket management system. Details of each of the associated tickets will be included in the timeline report.

In one embodiment, a user of the system may enable a feature to integrate the system with the user's security event management system, which is commonly referred to as a SIEM. This integration will allow the system to dynamically query the security event management system and associate the systems activities and the events and alerts within the security event management system. Details of each of the associated events and alerts will be included in the timeline report.

In some embodiments, the innovation involves dynamic cyber security event analysis and response testing of an organization, entity or managed service providers security analysts using the events generated by that organizations existing security tools and controls. The system may dynamically test security analysts in their existing environment without prior notice and without performing the testing on static/known systems in the security analyst's organization, entity or managed service providers environment. Significant breaches may have occurred because security analysts did not properly analyze security events in their environment, including breaches at Target. The analysts received the alerts, incorrectly determined those events/alerts were false positives, and allowed the breach to continue. The system may trigger events in the actual production environment which the analyst uses each day and dynamically change system, application process and user account information associated with the tests. With the introduction of dynamic variables, the analyst does not know and is not given any indication that a simulation or test by the system is underway. The system may then be able to accurately track which events each analyst successfully analyzed, how long that analysis took and which events the analysts did not properly detect or analyze and needs additional training on. The system may provide customers the ability to accurately measure the response and behavior of their security analysts using the tools, systems, accounts, and applications in the customers actual environment. This allows the organization to determine the likely dwell time of an actual threat actor and to undercover if their security analysts incorrectly categorize suspicious or malicious events as false positives. With this information the organization may determine which of their analysts' mis categorize events and correct that behavior with additional training. The system may execute dynamic and unpredictable events which may mimic the activity of actual cyber threat actors within an organizations actual network environment allows that organization to accurately determine the likely dwell time of a real threat actor while also enabling the organization to accurately measure if the organizations analysts or their managed service providers (MSP) analysts correctly analyze and classify events.

The present invention will now be described in detail with reference to embodiments thereof as illustrated in the accompanying drawings.

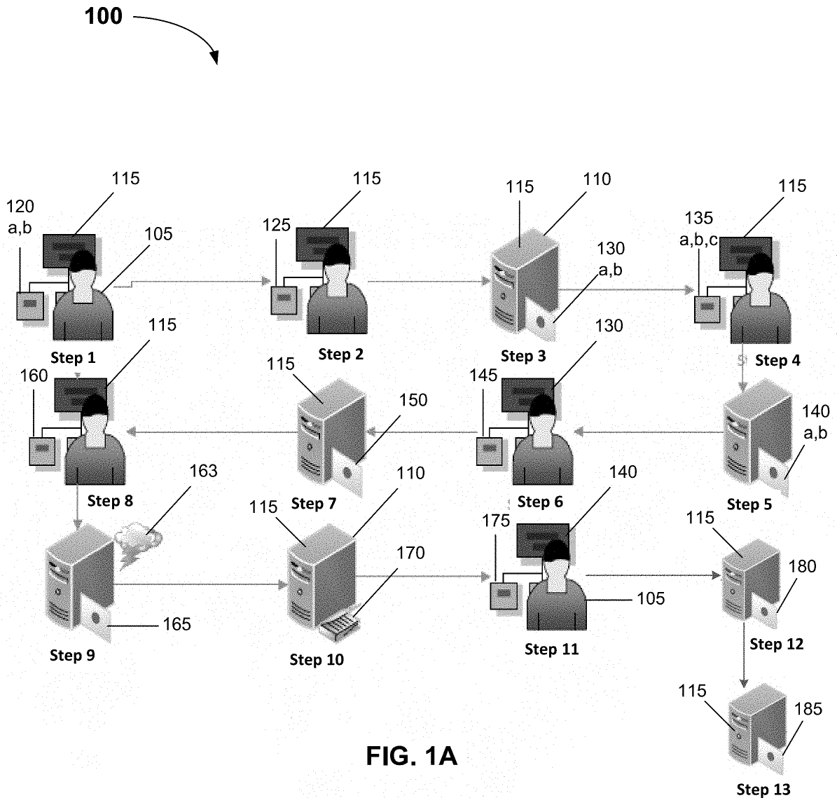

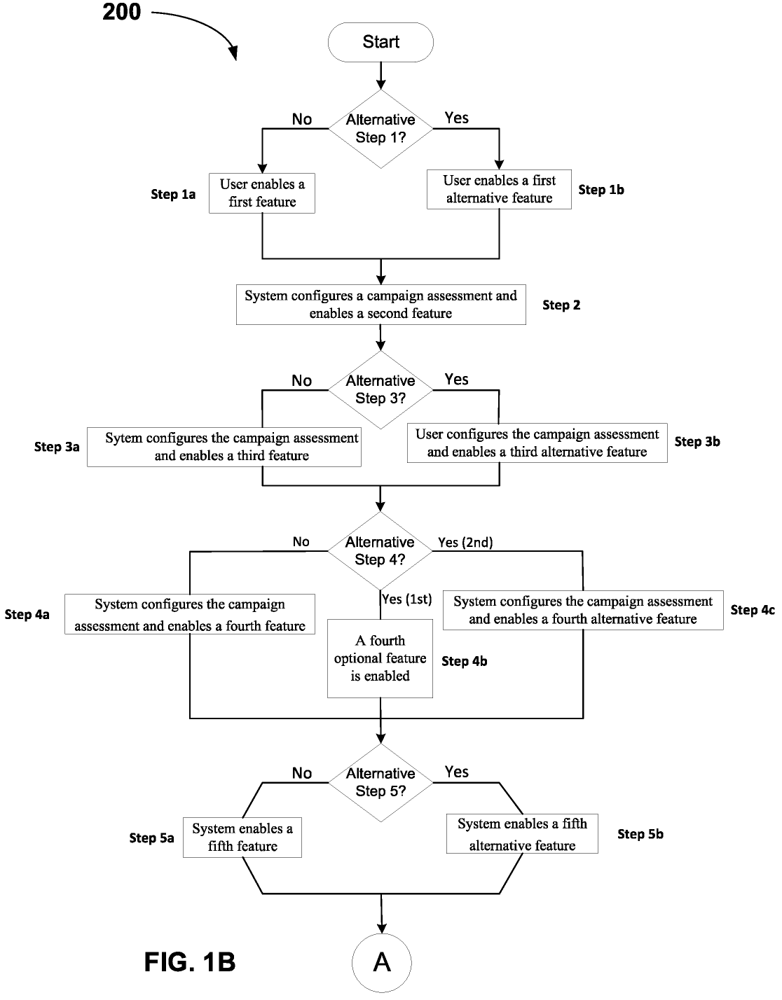

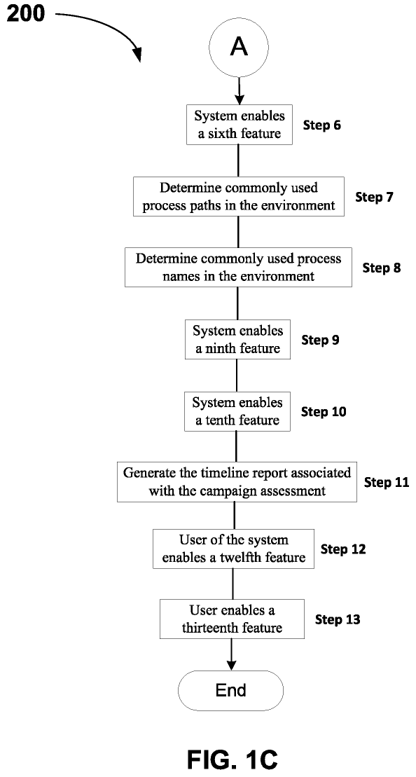

FIG. 1A is an illustration of an exemplary system and method 100 implementing a workflow for testing security analysts' ability to properly analyze security events occurring in an environment they are responsible for monitoring and FIG. 1B to FIG. 1C is an illustration of an exemplary flowchart 200 corresponding to workflow 100 of FIG. 1A, in accordance with an embodiment of the present invention. Referring to FIG. 1A through FIG. 1C, testing security analysts' ability to properly analyze security events occurring in an environment they are responsible for monitoring may include the following steps:

In a Step 1a, a user 105 of system 110 may enable a first feature 120a where the system dynamically generates an alert analysis, response, and containment validation campaign assessment where the system dynamically or randomly selects all criteria and features of a campaign assessment 115 where by a user of the system logs in to the system with credentials that have the appropriate privileges to enable or disable the first feature for the system to dynamically generate and randomly schedule one or more concurrent alert analysis, respond and containment validation campaign assessments in the users own environment. All additional features or settings may be dynamically and randomly set by the system and may not be visible or changeable by the users of the system. An example of the first process may involve the environments administrator for the system to logon and enable dynamic campaign assessments. After enabling the first feature, the administrator may log off the system. At some point in the future the system may initiate the campaign assessment without any notification to the administrator and/or the analysts responsible for the environment. At some point the administrator may connect back to the system. The only indication that the campaign assessment was either underway or had already concluded may be if one or more of the analysts in the environment successfully detected and documented the activity in the system.

In an alternative Step 1b, a user 105 of the system 110 enables a first alternative feature 120b where by the user of the system logs in to the system with credentials that have the appropriate privileges and enables the first feature to dynamically generate and randomly schedule an alert analysis, respond and containment validation campaign assessment 115, which unlike the initial feature, the system may send an email to one or more analysts who will be tested or quizzed on the campaign assessment. The email notification may be sent once the campaign assessment has concluded. The email notification may include a hint comprised of one or more details of one of the technique or sub-techniques in the campaign assessment. An example of the alternative process may involve the environments administrator for the system to logon and enable individual or team training campaign assessments. After enabling the first feature, the system may perform the necessary steps to create and execute the campaign assessment. The system may then send an email to the individuals that the administrator selected. The email may include details of one or more activities performed during the training campaign assessment. The analysts may perform their analysis and document their investigation findings in the system. The administrator may be able to logon to the system and review the investigation reports of each of the tested analysts and determine if there were activities that the analysts needed additional analysis training on.

In a Step 2, system 110 configures a campaign assessment 115 and enables a second feature 125 where the system, without input or influence of the user, dynamically adds a random set of defined threat actor techniques, sub-techniques, tests, tools, procedures, commands, behaviors, and/or activities, prior to beginning the campaign assessment. An example may involve the system having a library of at least ten (10) defined tests for each of but not a limitation, a Mitre ATT&CK Matrix tactics. The system may randomly select a subset of each tactics technique or sub-technique tests. The system may package up the details and necessary tools for those tests in preparation for that package to be delivered on to one of the test systems in the users environment.

In a Step 3a, system 110 configures the campaign assessment 115 and enables a third feature 130a to query the environment to determine the existing naming convention of systems in the environment under test whereby the system performs a query of the environments directory service to retrieve a list of known computer accounts in the environment. An example may involve the system performing an LDAP query to retrieve all computers in the environments Active Directory from the environments Domain Controllers. After analyzing a list of existing computer account names, the system may dynamically generate a new computer account or system name that closely matches the naming convention of the environment and may utilize the newly generated system name during the campaign assessment to rename the existing test system. An example of this may involve the system analyzing the results from its LDAP query for computer accounts in the environment where the analysis reveals the naming convention for systems in the environment are, but not limited to, WKSXXXX for workstations where the XXXX is a sequential number that is incremented by one for each new workstation deployed in the environment being tested and the WKS is the initial portion of the computer account name for that device type. The system may then generate a new computer account name that may combine a dynamically generated number along with the device type naming convention for the environment being tested for the workstation computer account name that did not match an existing computer account in the LDAP query results. As an example, if the LDAP query did not include a computer account name for WKS4567, the system may utilize that computer account name for the test system for the third campaign assessment.

In an alternative Step 3b, user 105 of the system configures the campaign assessment 115 to enable a third alternative feature 130b where the user of the system inputs the name or names of one or more existing systems which exist in the environment and are available for use by the system to install or deploy its processes. The system then dynamically or randomly selects one or more of the system names in the list prior to beginning the campaign assessment

In a Step 4a, system 110 configures the campaign assessment 115 to generally enable a fourth feature 135a to query the environment to determine the existing naming convention of user accounts in the environment. For example, the process may involve the system analyzing the results from, but not limited to, an LDAP query of the environments directory service for user accounts in the environment where the systems analysis reveals the naming convention for user accounts in the environment are, but not limited to, FIRSTNAME.LASTNAME for user accounts in the environment being tested. The system may generate a new user account name that would select from a list of common first names and last name combinations which did not match an existing user account in the LDAP query results. As an example, if the LDAP query results analysis did not include a user account for example Jane Smith, the system may utilize the dynamically generated and unused user account name for the test account utilized for the campaign assessment.

In an alternative Step 4b, system 110 may configure campaign assessment 115 to generally enable a fourth feature 135b where a user 105 of the system inputs a list of non-existent user account names determined by the user 105 of the system. The system 110 then dynamically or randomly selects a subset of the user accounts in the user provided list prior to beginning the campaign assessment.

In a second optional or alternative Step 4c, system 110 may enable fourth feature 135c where a user 105 of the system configuring the campaign assessment inputs the name or names of one or more existing user accounts which exist in the environment and are available for use by the system to execute or install its processes. The system may dynamically or randomly select one or more of the user accounts in the list prior to beginning the campaign assessment.

In a Step 5a, system 110 may enable a fifth feature 140a to query the environment being tested to determine the typical working hours in the environment. An example of this may involve the system performing a query of the centralized log management system of the environment being tested to collect events associated with logon and logoff activity for user accounts.

In an optional or alternative Step 5b, the system 110 may enable fifth feature 140b where user 105 of the system manually set the scheduled working hours to match the working hours of the time zone associated with the systems being tested prior to beginning the new campaign assessment. An example of the fifth feature may involve, but not limited to, user 105 determining a typical user account activity which may begin at 9 am local time and ends at 6 pm local time, Monday, Wednesday, and Friday. User 105 may configure the system 110 so it would only execute campaign assessment activity between the 9 am and 6 pm local time, on Monday, Wednesday, and Friday.

In a Step 6, system 110 may enable a sixth feature 145 to determine the typical working hours of the environment being tested System 110 may dynamically set the scheduled working hours for the campaign assessment to match the typical working hours of user accounts in the environment being tested. An example of this may involve the analysis determining the typical user account activity begins at 7 am local time and ends at 3 pm local time, Monday through Friday. The system 110 may schedule its testing activity during that same time.

In a Step 7, system 110 may enable a seventh feature 150 to query the environment to determine commonly used process paths in the environment. System 110 may dynamically or randomly generate a process path that closely matches that process path or paths that are currently not in use, renames the assessment application process path to the new name prior to beginning the campaign assessment. An example of this feature may be for system 110 to query the Windows event logs of the computers the systems agent has been installed on, looking for events with, for example, an Event Id of 4688. The events may include details on process paths where processes are being executed on computers in the environment where the analysts are being tested. Based on the analysis of those 4688 events to locate commonly used process paths, system 110 may conclude that processes in, for example, but not limited to, the C:\tools directory was in use frequently. System 110 may move it's process to the C:\tools directory before beginning the scheduled campaign assessment.

In a Step 8, system 110 may enable an eighth feature 160 to query the environment to determine commonly used process names in the environment. System 110 may generate a process name that closely matches that naming convention that is currently not in use, rename the campaign assessments process name to a new name prior to beginning the new campaign assessment. An example of the feature may be for system 110 to query the Windows event logs of the computers the systems agent has been installed on, looking for events with, for example, the Event Id of 4688. The events may include details on processes being executed on computers in the environment where the analysts are being tested. Based on the analysis of the 4688 events to locate commonly used process names, system 110 may conclude that an application such as but not limited to putty.exe was in use frequently. System 110 may rename it's process to putty.exe before beginning the scheduled campaign assessment.

In a Step 9, system 110 may enable a ninth feature 165 to define one or more technique and/or sub-technique artifacts or ‘flags’ 163. The flag or flags may be created on one or more test systems during the execution of technique and sub-technique test commands and include information that may associate the test command activity with the campaign assessment. The flags may be associated with one or more quizzes based upon the activity from the campaign assessment. An example of flag 163 may involve one of the test commands creating a text file on one of the systems involved with the campaign assessment. Inside the text file may be a unique code identifier along with text that may indicate the flag was created by system 110. An example flag code may be, but not limited to, NVIZ-7879dad778-789a7fa754-6655da. The flag may also include but not limited to the URL to system 110.

In a Step 10, system 110 may enable a tenth feature 170 that may track a dwell time of the campaign assessment. Specifically, the dwell time may be calculated for the amount of time between a campaign assessment's initial technique and/or sub-technique test command execution time and date and the time and date when the analyst correctly analyzes and documents the details of a flag and/or a test command associated with that same campaign assessment in system 110. In an example, the first activity of a campaign assessment may occur at 1:00 am on Jan. 1, 2022. An analyst detected a flag associated with that activity, accessed the system, and correctly entered the details of the activity on Jan. 5, 2022, at 12 pm. The system may then display a dwell time notice in system 110 which showed a dwell time of 108 hours for that specific campaign assessment.

In a Step 11, system 110 may enable an eleventh feature 175 that may generate the timeline report 160 associated with the campaign assessment. The timeline report provides a graphical representation of the time difference between the actual execution date and time of test commands in the organizations environment and the date and time correct analysis and logging of those threat actor test commands by a security analyst into the system 110. An example of the timeline report may graphically list details of each of the tests performed during the campaign assessment and could include, but not limited to, the date, time, Mitre tactic and technique ID and name along with details of test commands that were executed. The timeline may also include the date and time each test was detected and reported to system 110 by an analyst.

In a Step 12, user 105 of the system 110 may enable a twelfth feature 180 to integrate system 110 with the user's security ticket management system. The integration may allow the system to dynamically query the ticket management system and associate the systems activities and the tickets within the security ticket management system. Details of each of the associated tickets may be included in the timeline report. An example of the twelfth feature may be for the system to be integrated with, but not limited to, Service Now. After the conclusion of a campaign assessment the system queries the Service Now application and determined that 50% of the activity performed during the campaign assessment created tickets within Service Now. Of those, approximately 30% of the tickets may be marked as false positives and may not be escalated.

In a Step 13, user 105 of system 110 may enable a thirteenth feature 185 to integrate system 110 with user's 105 security information and event management system, which is commonly referred to as a SIEM. The integration may allow the system to dynamically query the security event management system and associate the systems activities and the events and alerts within the security event management system. Details of each of the associated events and alerts may be included in the timeline report. An example of the thirteenth feature may be for the system to be integrated with, but not limited to, Splunk. After the conclusion of a campaign assessment the system queries the Splunk application and may determine that 60% of the activity performed during the campaign assessment created alerts and approximately 15% of the activity was reported as blocked when the activity continued.

Those skilled in the art may readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that may be carried out on a computing machine, a typical computer system may, when appropriately configured or designed, serve as a computer system in which those aspects of the invention may be embodied.

In the following description, and for the purposes of explanation, numerous specific details may be set forth in order to provide a thorough understanding of the various aspects of the invention. It will be understood, however, by those skilled in the relevant arts, that the present invention may be practiced without the specific details. In other instances, known structures and devices may be shown or discussed more generally in order to avoid obscuring the invention. In many cases, a description of the operation is sufficient to enable one to implement the various forms of the invention, particularly when the operation is to be implemented in software. It should be noted that there may be many different and alternative configurations, devices, and technologies to which the disclosed inventions may be applied. The full scope of the inventions is not limited to the examples that are described below.

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples described and illustrated herein as being implemented in an individual or automated adversary simulation alert and event analysis and response validation system utilizing adversary tools, tactics, techniques and commands, the system described is provided as an example and not a limitation. As those skilled in the art will appreciate, the present examples may be suitable for application in a variety of adversary simulation alert, event analysis, and response assessments.

The invention describes an individual or automated adversary simulation alert, event analysis, response, escalation, containment, and eradication validation system. A typical example in this case may be when a member of the specific entity configures an adversary simulation alert, event analysis, response, escalation, containment and eradication assessment to test, document, assess, and validate the abilities and activities of the entity's security team members, managed security providers team members, or anyone associated with reviewing, analyzing, and responding to suspicious activity alerts for the entity.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that may be carried out on a computing machine, a typical computer system may, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew, or any other suitable programming language. The programs may be resident on a storage medium, e.g., magnetic, or optical, e.g., without limitation, the computer hard drive, a removable disk, or media such as, without limitation, a memory stick or SD media, or other removable medium. The programs may also be run over a network, for example, with a server or other machine sending signals to the local machine, which allows the local machine to carry out the operations described herein.

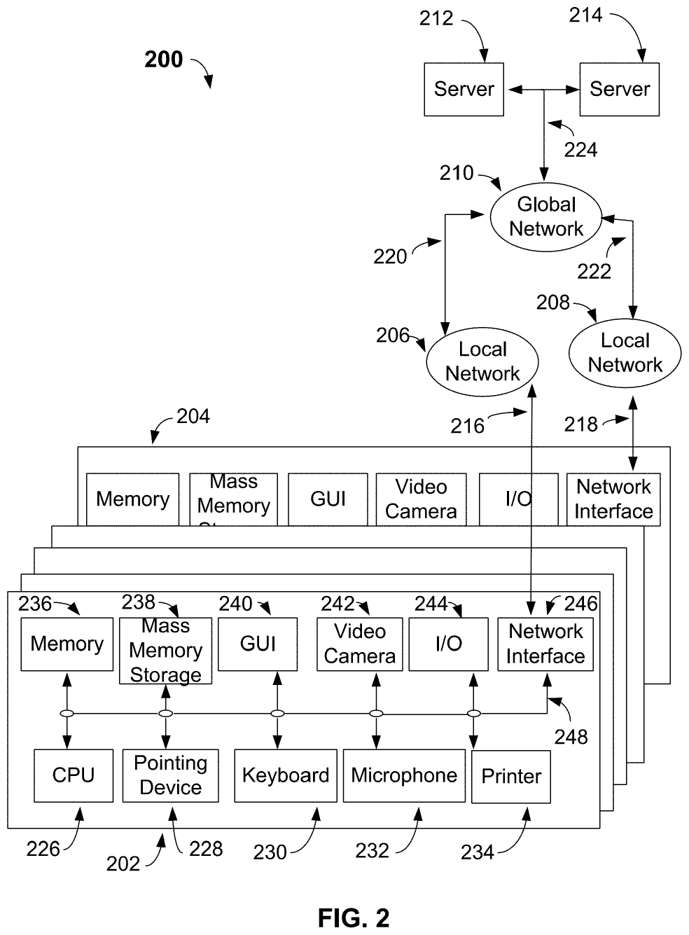

FIG. 2 is a block diagram depicting an exemplary client/server system which may be used by an exemplary web-enabled/networked embodiment of the present invention.

A communication system 200 includes a multiplicity of clients with a sampling of clients denoted as a client 202 and a client 204, a multiplicity of local networks with a sampling of networks denoted as a local network 206 and a local network 208, a global network 210 and a multiplicity of servers with a sampling of servers denoted as a server 212 and a server 214.

Client 202 may communicate bi-directionally with local network 206 via a communication channel 216. Client 204 may communicate bi-directionally with local network 208 via a communication channel 218. Local network 206 may communicate bi-directionally with global network 210 via a communication channel 220. Local network 208 may communicate bi-directionally with global network 210 via a communication channel 222. Global network 210 may communicate bi-directionally with server 212 and server 214 via a communication channel 224. Server 212 and server 214 may communicate bi-directionally with each other via communication channel 224. Furthermore, clients 202, 204, local networks 206, 208, global network 210 and servers 212, 214 may each communicate bi-directionally with each other.

In one embodiment, global network 210 may operate as the Internet. It will be understood by those skilled in the art that communication system 200 may take many different forms. Non-limiting examples of forms for communication system 200 include local area networks (LANs), wide area networks (WANs), wired telephone networks, wireless networks, or any other network supporting data communication between respective entities.

Clients 202 and 204 may take many different forms. Non-limiting examples of clients 202 and 204 include personal computers, personal digital assistants (PDAs), cellular phones and smartphones.

Client 202 includes a CPU 226, a pointing device 228, a keyboard 230, a microphone 232, a printer 234, a memory 236, a mass memory storage 238, a GUI 240, a video camera 242, an input/output interface 244 and a network interface 246.

CPU 226, pointing device 228, keyboard 230, microphone 232, printer 234, memory 236, mass memory storage 238, GUI 240, video camera 242, input/output interface 244 and network interface 246 may communicate in a unidirectional manner or a bi-directional manner with each other via a communication channel 248.

Communication channel 248 may be configured as a single communication channel or a multiplicity of communication channels.

CPU 226 may be comprised of a single processor or multiple processors. CPU 226 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 236 is used typically to transfer data and instructions to CPU 226 in a bi-directional manner. Memory 236, as discussed previously, may include any suitable computer-readable media, intended for data storage, such as those described above excluding any wired or wireless transmissions unless specifically noted. Mass memory storage 238 may also be coupled bi-directionally to CPU 226 and provides additional data storage capacity and may include any of the computer-readable media described above. Mass memory storage 238 may be used to store programs, data and the like and is typically a secondary storage medium such as a hard disk. It may be appreciated that the information retained within mass memory storage 238, may, in appropriate cases, be incorporated in standard fashion as part of memory 236 as virtual memory.

CPU 226 may be coupled to GUI 240. GUI 240 enables a user to view the operation of computer operating system and software. CPU 226 may be coupled to pointing device 228. Non-limiting examples of pointing device 228 include computer mouse, trackball, and touchpad. Pointing device 228 enables a user with the capability to maneuver a computer cursor about the viewing area of GUI 240 and select areas or features in the viewing area of GUI 240. CPU 226 may be coupled to keyboard 230. Keyboard 230 enables a user with the capability to input alphanumeric textual information to CPU 226. CPU 226 may be coupled to microphone 232. Microphone 232 enables audio produced by a user to be recorded, processed, and communicated by CPU 226. CPU 226 may be connected to printer 234. Printer 234 enables a user with the capability to print information to a sheet of paper. CPU 226 may be connected to video camera 242. Video camera 242 enables video produced or captured by user to be recorded, processed, and communicated by CPU 226.

CPU 226 may also be coupled to input/output interface 244 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 226 optionally may be coupled to network interface 246 which enables communication with an external device such as a database or a computer or telecommunications or internet network using an external connection shown generally as communication channel 216, which may be implemented as a hardwired or wireless communications link using suitable conventional technologies. With such a connection, CPU 226 might receive information from the network, or might output information to a network in the course of performing the method steps described in the teachings of the present invention.

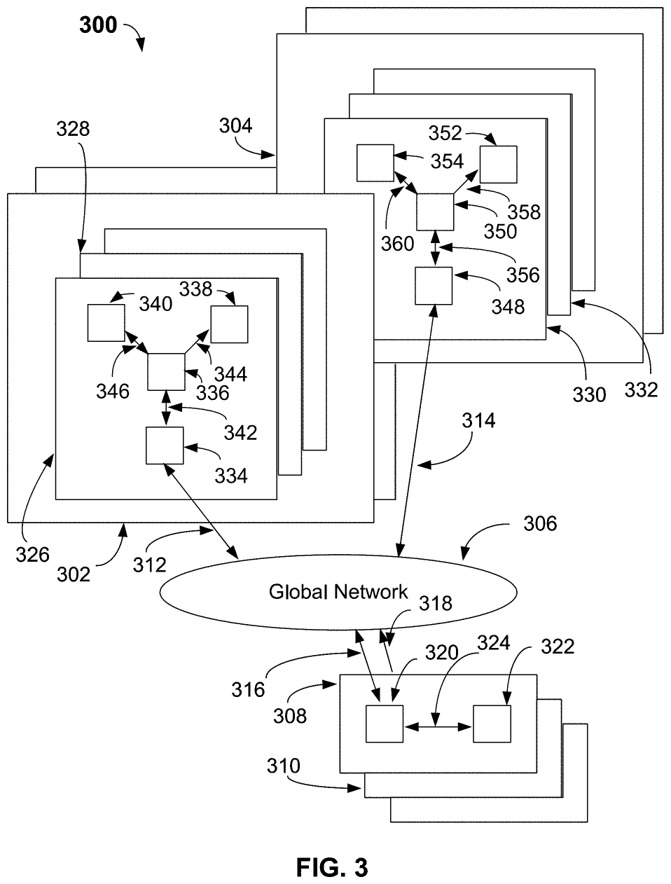

FIG. 3 illustrates a block diagram depicting a client/server communication system, which may be used by an exemplary web-enabled/networked embodiment of the present invention.

A communication system 300 includes a multiplicity of networked regions with a sampling of regions denoted as a network region 302 and a network region 304, a global network 306 and a multiplicity of servers with a sampling of servers denoted as a server device 303 and a server device 310.

Network region 302 and network region 304 may operate to represent a network contained within a geographical area or region. Non-limiting examples of representations for the geographical areas for the networked regions may include postal zip codes, telephone area codes, states, counties, cities, and countries. Elements within network region 302 and 304 may operate to communicate with external elements within other networked regions or within elements contained within the same network region.

In some implementations, global network 306 may operate as the Internet. It will be understood by those skilled in the art that communication system 300 may take many different forms. Non-limiting examples of forms for communication system 300 include local area networks (LANs), wide area networks (WANs), wired telephone networks, cellular telephone networks or any other network supporting data communication between respective entities via hardwired or wireless communication networks. Global network 306 may operate to transfer information between the various networked elements.

Server device 303 and server device 310 may operate to execute software instructions, store information, support database operations and communicate with other networked elements. Non-limiting examples of software and scripting languages which may be executed on server device 303 and server device 310 include C, C++, C# and Java.

Network region 302 may operate to communicate bi-directionally with global network 306 via a communication channel 312. Network region 304 may operate to communicate bi-directionally with global network 306 via a communication channel 314. Server device 303 may operate to communicate bi-directionally with global network 306 via a communication channel 316. Server device 310 may operate to communicate bi-directionally with global network 306 via a communication channel 313. Network region 302 and 304, global network 306 and server devices 303 and 310 may operate to communicate with each other and with every other networked device located within communication system 300.

Server device 303 includes a networking device 320 and a server 322. Networking device 320 may operate to communicate bi-directionally with global network 306 via communication channel 316 and with server 322 via a communication channel 324. Server 322 may operate to execute software instructions and store information.

Network region 302 includes a multiplicity of clients with a sampling denoted as a client 326 and a client 323. Client 326 includes a networking device 334, a processor 336, a GUI 333 and an interface device 340. Non-limiting examples of devices for GUI 333 include monitors, televisions, cellular telephones, smartphones, and PDAs (Personal Digital Assistants). Non-limiting examples of interface device 340 include pointing device, mouse, trackball, scanner, and printer. Networking device 334 may communicate bi-directionally with global network 306 via communication channel 312 and with processor 336 via a communication channel 342. GUI 333 may receive information from processor 336 via a communication channel 344 for presentation to a user for viewing. Interface device 340 may operate to send control information to processor 336 and to receive information from processor 336 via a communication channel 346. Network region 304 includes a multiplicity of clients with a sampling denoted as a client 330 and a client 332. Client 330 includes a networking device 343, a processor 350, a GUI 352 and an interface device 354. Non-limiting examples of devices for GUI 333 include monitors, televisions, cellular telephones, smartphones, and PDAs (Personal Digital Assistants). Non-limiting examples of interface device 340 include pointing devices, mousse, trackballs, scanners, and printers. Networking device 343 may communicate bi-directionally with global network 306 via communication channel 314 and with processor 350 via a communication channel 356. GUI 352 may receive information from processor 350 via a communication channel 353 for presentation to a user for viewing. Interface device 354 may operate to send control information to processor 350 and to receive information from processor 350 via a communication channel 360.

For example, consider the case where a user interfacing with client 326 may want to execute a networked application. A user may enter the IP (Internet Protocol) address for the networked application using interface device 340. The IP address information may be communicated to processor 336 via communication channel 346. Processor 336 may then communicate the IP address information to networking device 334 via communication channel 342. Networking device 334 may then communicate the IP address information to global network 306 via communication channel 312. Global network 306 may then communicate the IP address information to networking device 320 of server device 303 via communication channel 316. Networking device 320 may then communicate the IP address information to server 322 via communication channel 324. Server 322 may receive the IP address information and after processing the IP address information may communicate return information to networking device 320 via communication channel 324. Networking device 320 may communicate the return information to global network 306 via communication channel 316. Global network 306 may communicate the return information to networking device 334 via communication channel 312. Networking device 334 may communicate the return information to processor 336 via communication channel 342. Processor 336 may communicate the return information to GUI 333 via communication channel 344. User may then view the return information on GUI 333.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention may or should be located locally and which may or should be located remotely. Thus, for any claim's construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA. In some embodiments, the methods and/or system components which may be located and/or performed remotely include, without limitation:

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breath life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f)) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing cyber security event analysis and response testing according to the present invention will be apparent to those skilled in the art. Various aspects of the invention have been described above by way of illustration, and the specific embodiments disclosed are not intended to limit the invention to the particular forms disclosed. The particular implementation of the cyber security event analysis and response testing may vary depending upon the particular context or application. By way of example, and not limitation, the cyber security event analysis and response testing described in the foregoing were principally directed to cyber security event analysis and response testing implementations; however, similar techniques may instead be applied to data centers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

1. (canceled)

2. (canceled)

3. A method for assessing and/or testing an implemented security of a computing environment, the method comprising the steps for:
generating a first feature, wherein said first feature comprises generating an alert analysis and a response to the alert, in which said alert comprises at least one of a suspicious activity and a breach occurring in said computing environment;
generating a first campaign assessment;
randomly selecting a criteria of the first campaign assessment, said criteria including at least one of, techniques, sub-techniques, tools, procedures, test commands, behaviors, activities and flags; and
launching the first campaign assessment, wherein said first campaign assessment being configured to be operable for assessing and/or testing the implemented security of said computing environment.

4. The method of claim 3, further comprising the steps for:
executing the technique test command;
executing the sub-technique test command; and
creating a first flag during the execution of the technique and/or sub-technique test commands, in which the first flag comprises flag information being configured to be operable for associating the test command activity with the first campaign assessment.

5. The method of claim 4, in which the flag information comprises a unique code identifier and a text indicating the flag was created under the computing environment running the first campaign assessment.

6. The method of claim 5, further comprising the steps for:
tracking a dwell time of the first campaign assessment; and
calculating the dwell time of the first campaign assessment.

7. The method of claim 6, wherein the dwell time comprises an amount of time between the execution of the technique test command and the sub-technique test command and the time and date when an analyst correctly documents details of the flag and/or the test command associated with the first campaign assessment.

8. The method of claim 4, further comprising the step of sending an email to one or more analysts' or selected individuals, in which the email comprises a hint of one or more details of the technique or sub-techniques in the first campaign assessment.

9. The method of claim 4, further comprising the steps for:
creating a second campaign assessment, wherein said second campaign assessment being configured to be operable for further assessing and/or testing the security of said computing environment;
querying the computing environment;
determining a naming convention of the computing environment; and
dynamically and/or randomly generating one or more system names that closely matches the naming convention.

10. The method of claim 9, further comprising the step of renaming the computing environment to the generated system name or names prior to launching the second campaign assessment.

11. The method of claim 9, further comprising the steps for:
creating one or more system instances or virtual systems;
generating system names that closely matches the naming convention within said computing environment;
assigning the one or more generated system names that closely matches the naming convention to the one or more system instances or virtual systems prior to launching the second campaign assessment.

12. The method of claim 4, further comprising the steps for:
creating a new campaign assessment, wherein said new campaign assessment being configured to be operable for further assessing and/or testing the security of said computing environment;
inputting a list of one or more system names for installing or deploying processes within the computing environment; and
dynamically or randomly selecting one or more of the systems names in the list prior to launching the new assessment campaign.

13. The method of claim 4, further comprising the steps for:
creating a new campaign assessment, wherein said new campaign assessment being configured to be operable for further assessing and/or testing the security of said computing environment;
inputting a list of one or more user accounts used for executing or installing processes in the computing environment; and
dynamically or randomly selecting one or more of the user accounts in the list prior to launching the new campaign assessment.

14. The method of claim 4, further comprising the steps for:
creating a new campaign assessment, wherein said new campaign assessment being configured to be operable for further assessing and/or testing the security of said computing environment;
inputting a list of one or more non-existent user accounts in the computing environment; and
dynamically or randomly selecting a subset of the user accounts in a user provided list prior to launching the new assessment campaign.

15. A non-transitory program computer-readable media tangibly embodying a program of instructions executable by one or more processors to perform a method for assessing and/or testing a security of a computing environment, the method comprising the steps for:
generating an alert analysis related to suspicious activities and/or a breach within said computing environment;
generating a response to the alert based on the alert analysis;
generating a first assessment campaign, wherein said first assessment campaign being configured to be operable for assessing and/or testing the security of said computing environment;
randomly selecting a criteria of said first campaign assessment, said criteria including at least one of, techniques, sub-techniques, tools, procedures, test commands, behaviors, activities and flags; and
launching the first assessment campaign.

16. The method of claim 15, further comprising the steps for:
creating a new assessment campaign, wherein said new assessment campaign is configured to further assess and/or test the security of said computing environment;
querying the computing environment;
determining commonly used process path or paths in the computing environment;
dynamically or randomly generating a process path or paths that closely matches the commonly used process path or paths, wherein the generated process path or paths are currently not in use; and
renaming the generated process path or paths to a new name prior to launching the new assessment campaign.

17. The method of claim 15, further comprising the steps for:
creating a new assessment campaign, wherein said new assessment campaign is configured to further assess and/or test the security of said computing environment;
selecting a random set of threat actor technique and/or sub-technique tests;
enabling the random set of threat actor technique and/or sub-technique tests;
verifying predetermined information for the random set of threat actor technique and/or sub-technique tests are correctly configured prior to beginning the new assessment campaign.

18. The method of claim 17, further comprising the steps for:
documenting a timeline of one or more activities of a team member associated with the new assessment campaign;
concluding the new assessment campaign;
creating a report after the conclusion of the new assessment campaign;
scheduling a team review of the one or more activities associated with the assessment; and
comparing the one or more activities to actual behaviors, response, escalation, containment and eradication activities of the team.

19. The method of claim 15, further comprising the steps for:
creating a new assessment campaign, wherein said new assessment campaign is configured to further assess and/or test the security of said computing environment;
querying the computing environment;
determining typical working hours in the computing environment; and dynamically setting scheduled working hours for the new assessment campaign, prior to beginning the new assessment campaign.

20. A non-transitory program computer-readable media tangibly embodying a program of instructions executable by one or more processors to perform a method for assessing and/or testing an implemented security of a computing environment, the method comprising the steps for:
generating an alert analysis related to suspicious activities and/or a breach within said computing environment;
generating a response to the alert based on the alert analysis;
generating an assessment campaign, wherein said assessment campaign being configured to be operable for assessing and/or testing the implemented security of said computing environment;
randomly selecting a criteria of said campaign assessment, in which said criteria including at least one of, techniques, sub-techniques, tools, procedures, test commands, behaviors, activities and flags; and
launching the assessment campaign.

21. The method of claim 20, further comprising the steps for:
integrating the assessment campaign with a security ticket management solution;
querying the ticket management solution; and
associating the assessment campaign activities and tickets within the security ticket management solution; and
including in a timeline report detail of each of the tickets.

22. The method of claim 15, further comprising the steps for:
integrating the assessment campaign with a security event management solution;
querying the security event management solution; and
associating the assessment campaign activities and events and alerts within the security event management solution; and
including in a timeline report detail of events and alerts.
